(19) United States
(12) Patent Application Publication
(10) Pub. No.: US 2010/0159434 A1
(43) Pub. Date: Jun. 24, 2010

(54) Mixed Simulator and Uses Thereof

(76) Inventors: Samsun Lampotang, Gainesville, FL (US); Benjamin Lok, Gainesville, FL (US); Paul Anthony Fishwick, Gainesville, FL (US); John P. Quarles, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/664,222

(22) PCT Filed: Oct. 13, 2008
(86) PCT No.: PCT/US08/79687

§ 371 Date: Feb. 8, 2010

Related U.S. Application Data
(60) Provisional application No. 60/979,133, filed on Oct. 11, 2007.

(51) Int. Cl. G09B 25/00; G06G 7/48

(52) U.S. Cl. 434/365; 703/6

(57) ABSTRACT

The subject invention provides mixed simulator systems that combine the advantages of both physical objects/simulations and virtual representations. In-context integration of virtual representations with physical simulations or objects can facilitate education and training. Two modes of mixed simulation are provided. In the first mode, a virtual representation is combined with a physical simulation or object by using a tracked display capable of displaying an appropriate dynamic virtual representation as a user moves around the physical simulation or object. In the second mode, a virtual representation is combined with a physical simulation or object by projecting the virtual representation directly onto the physical object or simulation. In further embodiments, user action and interaction can be tracked and incorporated within the mixed simulator system to provide a mixed reality after-action review. The subject mixed simulators can be used in many applications including, but not limited to healthcare, education, military, vocational schools, and industry.

### CROSS REFERENCE TO RELATED APPLICATION

The present application claims the benefit of U.S. provisional patent application Ser. No. 60/979,133, filed Oct. 11, 2007, which is hereby incorporated by reference in its entirety.

### BACKGROUND

In general, a simulation provides representations of certain key characteristics or behaviors of a selected physical or abstract system. Simulations can be used to show the effects of particular courses of action. A physical simulation is a simulation in which physical objects are substituted for a real thing or entity. Physical simulations are often used in interactive simulations involving a human operator for educational and/or training purposes. For example, mannequin patient simulators are used in the healthcare field, flight simulators and driving simulators are used in various industries, and tank simulators may be used in military training.

Physical simulations or objects provide a real tactile and haptic feedback for a human operator and a 3-dimensional (3-D) interaction perspective suited for learning psycho-motor and spatial skills.

In the health care industry, as an example, medical simulators are being developed to teach therapeutic and diagnostic procedures, medical concepts, and decision making skills. Many medical simulators involve a computer or processor connected to a physical representation of a patient, also referred to as a mannequin patient simulator (MPS). These MPSs have been widely adopted and consist of an instrumented mannequin that can sense certain interventions and, via mathematical models of physiology and pharmacology, the mannequin reacts appropriately in real time. For example, upon sensing an intervention such as administration of a drug, the mannequin can react by producing an increased palpable pulse at the radial and carotid arteries and displaying an increased heart rate on a physiological monitor. In certain cases, real medical instruments and devices can be used with the life-size MPSs and proper technique and mechanics can be learned.

Physical simulations or objects are limited by the viewpoint of the user. In particular, physical objects such as anesthesia machines (in a medical simulation) and car engines (in a vehicle simulation) and physical simulators such as MPSs (in a medical simulation) remain a black-box to learners in the sense that the internal structure, functions and processes that connect the input (cause) to the output (effect) are not made explicit. Unlike a user's point of reference in an aircraft simulator where the user is inside looking out, the user's point of reference in, for example, a mannequin patient simulator is from the outside looking in any direction at any object, but not from within the object. In addition, many visual cues such as a patient's skin turning cyanotic (blue) from lack of oxygen are difficult to simulate. These effects are often represented by creative substitutes such as blue make-up and oatmeal vomit. However, in addition to making a mess, physically simulated blood gushing from a simulated wound or vomit can potentially cause short-circuits because of the electronics in a MPS.

Virtual simulations have also been used for education and training. Typically, the simulation model is instantiated via a display such as computer, PDA or cell phone screens, or stereoscopic, 3-D, holographic or panoramic displays. An intermediary device, often a mouse, joystick, or Wii™, is needed to interact with the simulation.

Virtual abstract simulations, such as transparent reality simulations of anesthesia machines and medical equipment or drug dissemination during spinal anesthesia, emphasize internal structure, functions and processes of a simulated system. Gases, fluids and substances that are usually invisible or hidden can be made visible or even color-coded and their flow and propagation can be visualized within the system. However, in a virtual simulation without the use of haptic gloves, the simulator cannot be directly touched like a physical simulation. In the virtual simulations, direct interaction using one's hands or real instruments such as laryngoscopes or a wrench is also difficult to simulate. For example, it can be difficult to simulate a direct interaction such as turning an oxygen flowmeter knob or opening a spare oxygen cylinder in the back of the anesthesia machine.

In addition, important tactile and haptic cues such as the deliberately fluted texture of an oxygen flowmeter knob in an anesthesia machine are missing. Furthermore, the emphasis on internal processes and structure may cause the layout of the resulting virtual simulation to be abstracted and simplified and thus different from the actual physical layout of the real system. This abstract representation, while suited for assisting learning by simplification and visualization, may present challenges when transferring what was learned to the actual physical system.

One example of a virtual simulation is the Cave Automatic Virtual Environment (CAVE™), which is an immersive virtual reality environment where projectors are directed to three, four, five, or six of the walls of a room-sized cube. However, CAVE™ systems tend to be unwieldy, bulky, and expensive.

Furthermore, monitor-based 2-dimensional (2-D) or 3-D graphics or video based simulations, while easy to distribute, may lack in-context integration. In particular, the graphics or video based simulations can provide good abstract knowledge, but research has shown that they may be limited in their ability to connect the abstract to the physical.

Accordingly, there is a need for a simulation system capable of in-context integration of virtual representations with a physical simulation or object.

### BRIEF SUMMARY

The subject invention provides mixed simulator systems that combine the advantages of both physical objects/simulations and virtual representations. Two modes of mixed simulation are provided. In the first mode, a virtual representation is combined with a physical simulation or object by using a tracked display capable of displaying an appropriate dynamic virtual representation as a user moves around the physical simulation or object. The tracked display can display an appropriate virtual representation as a user moves or uses the object or instrument. In the second mode, a virtual representation is combined with a physical simulation or object by projecting the virtual representation directly onto the physical object or simulation. In preferred embodiments of the second mode, the projection includes correcting for unevenness of the surface onto which the virtual representation is projected. In addition, the user's perspective can be tracked and used in adjusting the projection.

Embodiments of the mixed simulator system are inexpensive and highly portable. In one embodiment for a medical implementation, the subject mixed simulator incorporates existing mannequin patient simulators as the physical simulation component to leverage off the large and continuously growing number of mannequin patient simulators in use in healthcare simulation centers worldwide.

Advantageously, with a mixed simulator according to the present invention, the physical simulation is no longer a black box. A virtual representation is interposed or overlaid over a corresponding part of a physical simulation or object. Using such virtual representations, virtual simulations that focus on the internal processes or structure not visible with a physical simulation can be observed in real time while interacting with the physical simulation.

Beyond the physical object or simulator and its corresponding virtual representation, other instruments, diagnostic tools, devices, accessories and disposables commonly used with the physical object or simulator can also be tracked. Such other instruments and devices can be a scrub applicator, a laryngoscope, syringes, endotracheal tube, airway devices and other healthcare devices in the case of a mannequin patient simulator. In the case of an anesthesia machine, the instruments can include, for example, a low pressure leak test suction bulb, a breathing circuit, a spare compressed gas cylinder, a cylinder wrench or gas pipeline hose. In the case of a car engine, the instruments can include, for example, a wrench or any other automotive accessories, devices, tools or parts. By tracking the accessory instruments, devices and components, the resulting mixed simulation can thus take into account and react accordingly to a larger set of interactions between the user, physical object and instrument. This can include visualizing, through the virtual representation, effects that are not visible, explicit or obvious, such as the efficacy of skin sterilization and infectious organism count when the user is applying a tracked scrub applicator (that applies skin sterilizing agent) over a surface of the mannequin patient simulator.

The virtual representations can be abstract or concrete. Abstract representations include, but are not limited to, inner workings of a selected object or region and can include multiple levels of detail such as surface, sub-system, organ, functional blocks, structural blocks or groups, cellular, molecular, atomic, and sub-atomic representations of the object or region. Concrete representations reflect typical clues and physical manifestations of an object, such as, for example, a representation of vomit or blue lips on a mannequin.

Specifically exemplified herein is a mixed simulation for healthcare training. This mixed simulation is particularly useful for training healthcare professionals including physicians and nurses. It will be clear, however, from the descriptions set forth herein that the mixed simulation of the subject invention finds application in a wide variety of healthcare, education, military, and industry settings including, but not limited to, simulation centers, educational institutions, vocational and trade schools, museums, and scientific meetings and trade shows.

### BRIEF DESCRIPTION OF THE DRAWINGS

FIGS. 1A and 1B show a mixed simulation system incorporating a hand-held display and a physical mannequin patient simulator according to one embodiment of the present invention.

FIG. 2 shows a mixed simulation system incorporating a projector and a physical mannequin patient simulator according to one embodiment of the present invention.

FIG. 3 shows a diagram of a tracking system according to an embodiment of the present invention.

FIGS. 4A-4C show a mixed simulation system incorporating a hand-held display and an anesthesia machine according to an embodiment of the present invention.

FIG. 5 shows a real-world view of a user touching an incompetent inspiratory valve and a view of an incompetent inspiratory valve in the virtual display according to an embodiment of the present invention.

FIG. 6 shows a window providing a look-at indicator available during after-action review in accordance with an embodiment of the present invention.

FIG. 7 shows a window for past interaction boxes available during after-action review in accordance with an embodiment of the present invention.

FIG. 8 shows a block diagram of a specific implementation of the tracking system in accordance with an embodiment of the present invention.

FIG. 9 shows a functional block diagram of a mixed simulator system according to an embodiment of the present invention.

FIG. 10 illustrates transforming a 2-D VAM component to contextualized 3-D in accordance with an embodiment of the present invention.

FIG. 11 shows three states of the mechanical ventilator controls for the VAM.

FIGS. 12A and 12B show pipes between components where the pipes represent the diagrammatic graph arcs. FIG. 12A shows the VAM arcs of simple 2-D paths; and

FIG. 12B shows the arcs transformed to 3-D.

### DETAILED DISCLOSURE

The subject invention pertains to mixed simulations incorporating virtual representations with physical simulations or objects. The subject invention can be used in, for example, healthcare, industry, and military applications to provide educational and test scenarios.

Advantageously, the current invention provides an in-context integration of an abstract representation (e.g., transparent reality whereby internal, hidden, or invisible structure, function and processes are made visible, explicit and/or adjustable) with the physical simulation or object. Thus, in certain embodiments, the subject invention provides an abstract representation over a corresponding area of the physical simulation or object. In addition, concrete virtual representations can be provided with respect to the physical simulation or object. In further embodiments, representations can be provided for the interactions, relationships and links between objects, where the objects can be, but are not limited to, simulators, equipment, machinery, instruments and any physical entity.

The subject mixed simulator combines advantages of both physical simulations or objects and virtual representations such that a user has the benefit of real tactile and haptic feedback with a 3-D perspective, and the flexibility of virtual images for concrete and abstract representations. As used herein, a “concrete representation” is a true or nearly accurate representation of an object. An “abstract representation” is a simplified or extended representation of an object and can include features on a cut-out, cross-sectional, simplified, schematic, iconic, exaggerated, surface, sub-system, organ, functional blocks, structural blocks or groups, cellular, molecular, atomic, and sub-atomic level. The abstract representation can also include images typically achieved through medical or other imaging techniques, such as MRI scans, CAT scans, echography scans, ultrasound scans, and X-ray.

A virtual representation and a physical simulation or object can be combined using implementations of one of two modes of mixed simulation of the present invention.

In the first mode, a virtual representation is combined with a physical simulation or object by using a tracked display capable of displaying an appropriate dynamic virtual representation as a user/viewer moves around the physical simulation or object. The tracked display can be interposed between the viewer(s) and the physical object or simulation whereby the display displays the appropriate dynamic virtual representation as viewers move around the physical object or simulation or move the display. Accordingly, the tracked display can provide a virtual representation for the physical object or simulation within the same visual space of a user. The display can be hand-held or otherwise supported, for example, with a tracked boom arm. The virtual representations provided in the display can be abstract or concrete.

According to embodiments, tracking can be performed with respect to the display, a user, and the physical object or simulation. Tracking can also be performed with respect to associated instruments, devices, tools, peripherals, parts and components. In one embodiment where multiple users are performing the mixed simulation at the same time, the tracking can be simultaneously performed with respect to the multiple users and/or multiple displays. Registration of the virtual objects provided in the display with the real objects (e.g., the physical object or simulator) can be performed using a tracking system. By accurately aligning virtual objects within the display with the real objects (e.g., the physical object or simulator), they can appear to exist in the same space. In an embodiment, any suitable tracking system can be used to track the user, the display and/or the physical object or simulator. Examples include tracking fiducial markers, using stereo images to track retro-reflective IR markers, or using a markerless system. Optionally, a second vision-based tracker (marker or markerless) can be incorporated into embodiments of the present invention. In one such embodiment, an imaging device can be mounted on the display device to capture images of the physical objects. The captured images can be used with existing marker or markerless tracking algorithms to more finely register the virtual objects atop the physical objects. This can enhance the overall visual quality and improve the accuracy and scope of the interaction.

A markerless system can use the image formed by a physical object captured by an imaging device (such as a video camera or charge coupled device) attached to the display and a model of the physical object to determine the position and orientation of the display. As an illustrative example, if the physical object is an upright cylinder and the image of the physical object captured by the imaging device appears as a perfect circle, then the imaging device and thus the display are directly over the cylinder (plan view). If the circle appears small, the display is further away from the physical object compared to a larger appearing circle. On the other hand, if the display is at the side of the upright cylinder (elevation view), the imaging device would produce a rectangle whose size would again vary with the distance of the imaging device and thus the display from the physical object.

Through the display, users can view a first-person perspective of an abstract or concrete representation with a photorealistic or 3-D model of the real object or simulation. The photorealistic or 3-D model appears on the lens in the same position and orientation as the real physical object or simulation, as if the display was a transparent window (or a magnifying glass) and the user was looking through it. This concept can include implementations of a ‘magic lens,’ which shows underlying data in a different context or representation.

Magic Lenses were originally created as 2-D interfaces that are movable, semi-transparent ‘regions of interest’ that show the user a different representation of the information underneath the lens. Magic lenses can be used for such operations as magnification, blur, and previewing various image effects. Often, each lens represented a specific effect. If the user wanted to combine effects, two lenses could be dragged over the same area, producing a combined effect in the overlapping areas of the lens. According to embodiments of the present invention, the capabilities of multiple magic lenses can be integrated into a single system. That is, the display can provide the effects of multiple magic lenses.

Accordingly, embodiments of the present invention can integrate the diagram-based, dynamic, transparent reality model into the context of the real object or physical simulator using a “see-through” magic lens (i.e. a display window). For the see-through effect, the display window displays a scaled high-resolution 3-D model of the object or physical simulator that is registered to the object or real simulator. As described here, the see-through functionality is implemented using a 3-D model of the real object or physical simulator. Although not a preferred embodiment, another technique may utilize a video see-through technique where abstract components are superimposed over a live photorealistic video stream.

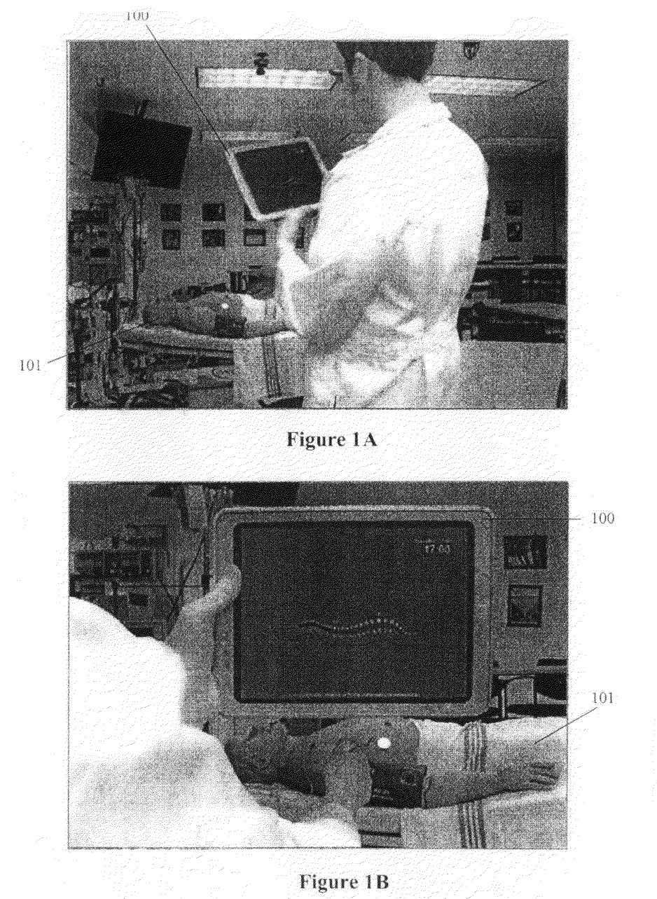

FIGS. 1A and 1B show concept pictures of a mixed simulator system incorporating a hand-held display 100 and physical mannequin patient simulator 101 according to an embodiment of the present invention. In FIGS. 1A and 1B, an abstract representation of the distribution over time of an anesthetic (shown as a darkened region) in the spinal cavity is interposed over the mannequin patient simulator. By viewing the abstract model while interacting with the physical mannequin patient simulator, a user can more clearly understand the processes, functions, and structures, including those that are transparent, internal, hidden, invisible, conceptual or not easily distinguished, of the physical object or simulation. The models driving the distribution of anesthetic in the abstract, virtual representation determine if the anesthetic migrates to the cervical area of the spine that controls breathing and causes loss of spontaneous breathing. The virtual simulation communicates that information back to the MPS (mannequin patient simulator) so that the physically simulated spontaneous breathing in the MPS becomes blunted.

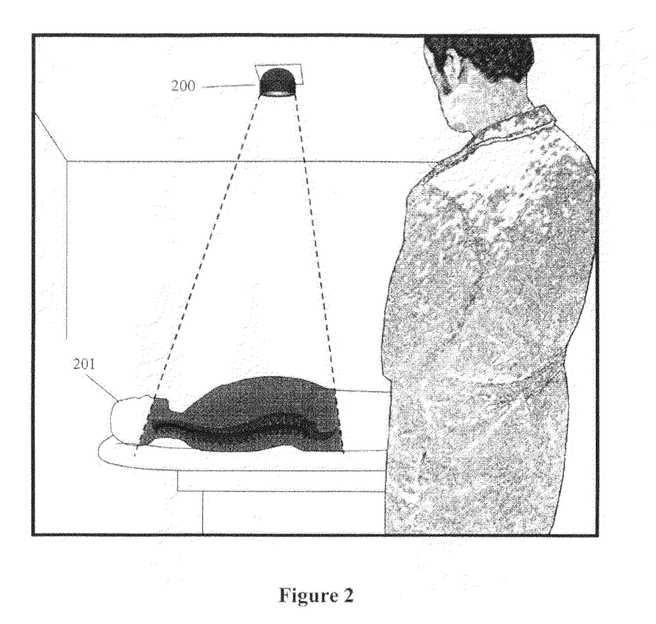

In the second mode, a virtual representation is combined with a physical simulation or object by projecting the virtual representation directly onto the physical object or simulation. FIG. 2 shows a concept view of a mixed simulator system incorporating a projector 200 and physical mannequin patient simulator 201 according to an embodiment of the present invention. Referring to FIG. 2, the projector 200 can be ceiling mounted. An abstract representation of the distribution over time of an anesthetic (shown as a darkened region) in the spinal cavity is projected directly onto the MPS 201, which is a physical object and also a physical simulator.

The virtual representation can be projected correcting for unevenness, or non-flatness, of the surface onto which the virtual representation is projected. In addition, the user's perspective can be tracked and used in adjusting the projection. The virtual representation can be abstract or concrete.

In one embodiment, to correct for a non-flat projection surface on the physical object or simulation, a checkerboard pattern (or some other pattern) can be initially projected onto the non-flat surface and the image purposely distorted via a software implemented filter until the projection on the non-flat surface results in the original checkerboard pattern (or other original pattern). The virtual representation can then be passed through the filter so that the non-flat surface does not end up distorting the desired abstract or concrete virtual representation.

In both modes, the location of the physical simulation or object can be tracked if the physical simulation or object moves, and the location of the physical simulation or object can be registered within the 3-D space if the physical simulation or object remains stationary.

According to one embodiment of the present invention, the display interposes the appropriate representation (abstract or concrete) over the corresponding area of the physical simulation or object. The orientation and position of the display can be tracked in a 3-D space containing a physical simulation, such as a MPS, or object such, as an anesthesia machine or car engine. As an example of a concrete virtual representation, when placing the display between the viewer(s) and the mannequin head, as used in the first mode described above, a virtual representation that looks like the head of the mannequin (i.e., a concrete virtual representation) will be interposed over the head of the physical mannequin and the lips in the virtual representation may turn blue (to simulate cyanosis) or vomit may spew out to simulate vomiting virtually. Alternatively, as used in the second mode described above, blue lip color can be projected onto the lips of the MPS to indicate the patient's skin turning cyanotic. Advantageously, these approaches provide a means to do the “messy stuff” virtually with a minimum of spills and cleanup. Also, identifiable features related to different attributes and conditions such as age, gender, stages of pregnancy, and ethnic group can be readily represented in the virtual representation and overlaid over a “hard-coded” physical simulation, such as a mannequin patient simulator.

The mixed simulator can provide the viewing of multiple virtual versions that are registered with the physical object. This is done as a means to overcome the limitations of easily and quickly modifying the physical object. The multiple virtual versions that are mapped to the physical object allow for training and education of many complex concepts not afforded with existing methods.

For example, the virtual human model registered with the physical human patient simulator can represent different gender, different size, and different ethnic patients. The user sees the dynamic virtual patient while interacting with the human patient simulator as inputs to the simulation. The underlying model to the physical simulation is also modified by the choice of virtual human, e.g. gender or weight specific physiological changes.

An abstract representation might instead interpose a representation of the brain over the head of the MPS with the ability to zoom in to the blood brain barrier and to cellular, molecular, atomic and sub-atomic abstract representations. Another abstract virtual representation would be to interpose abstract representations of an anesthesia machine over an actual anesthesia machine. By glancing outside the display, users instantly obtain the context of an abstract or concrete virtual representation as it relates to the concrete physical simulation or object.

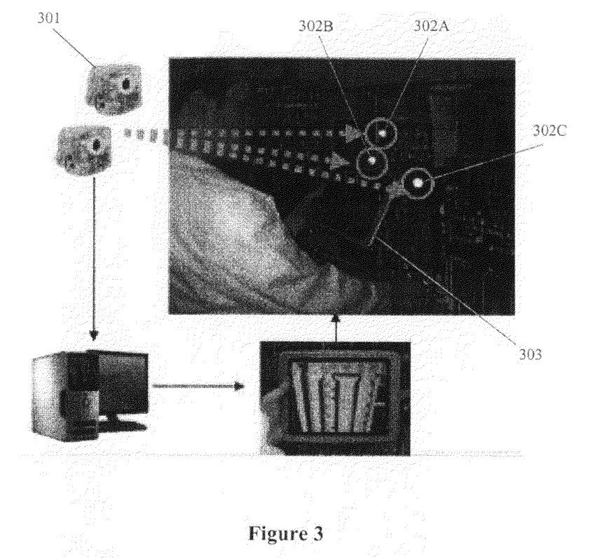

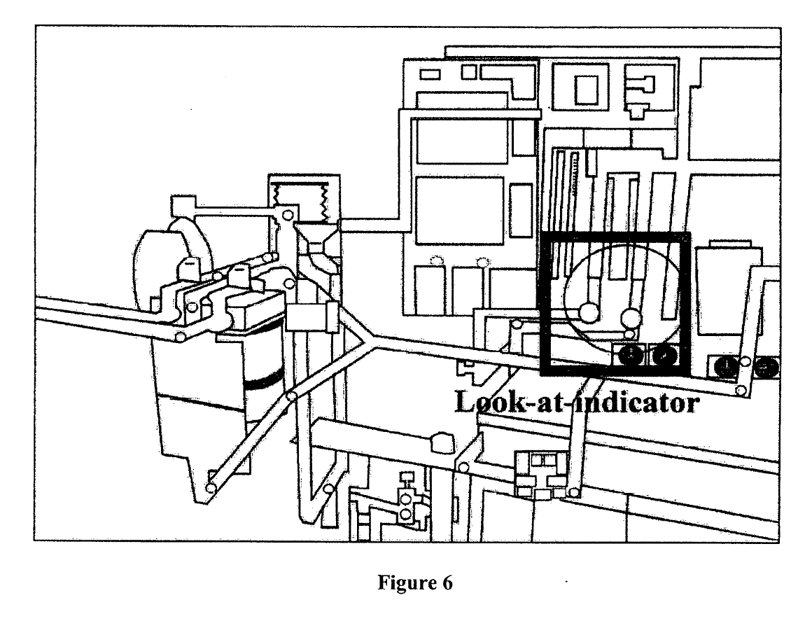

In a specific example, a tracking system similar to what would be used to track a display used with a physical MPS in a 3-D space is implemented for tracking a display used with a real anesthesia machine and interposing abstract representations of the internal structure and processes in an anesthesia machine. An example of this system is conceptually shown in FIGS. 3 and 8. To track the position and orientation of the display instantiating the magic lens capabilities, the tracking system can use a computer vision technique called outside-looking-in tracking (see e.g., “Optical Tracking and Calibration of Tangible Interaction Devices,” by van Rhijn et al. (Proceedings of the Immersive Projection Technology and Virtual Environments Workshop 2005), which is hereby incorporated by reference in its entirety). The outside-looking-in tracking technique uses multiple stationary cameras that observe special markers attached to the objects being tracked (in this case the object being tracked is the display 303). The images captured by the cameras can be used to calculate positions and orientations of the tracked objects. The cameras are first calibrated by having them all view an object of predefined dimensions. Then the relative position and orientation of each camera can be calculated. After calibration, each camera searches each frame's images for the markers attached to the lens; then the marker position information from multiple cameras is combined to create a 3-D position and orientation of the tracked object. To reduce this search, embodiments of the subject system use cameras with infrared lenses and retro-reflective markers (balls) that reflect infrared light. This particular system uses IR cameras 301 to track fiducial markers (reflective balls 302a, 302b, and 302c) on the display 303 which could be hand-held or otherwise supported. Thus, the cameras 301 see only the reflective balls (302a, 302b, and 302c) in the image plane. Each ball has a predefined relative position to the other two balls. Triangulating and matching the balls from at least two camera views can facilitate calculation of the 3-D position and orientation of the balls. Then this position and orientation can be used for the position and orientation of the magic lens provided by the display 303.

The position and orientation of the display can be used to render the 3-D model of the machine from the user's current perspective. Although tracking the lens alone does not result in rendering the exact perspective of the user, it gives an acceptable approximation as long as users know where to hold the lens in relation to their head. To accurately render the 3-D machine from the user's perspective independent of where the user holds the lens in relation to the head, both the user's head position and the display can be tracked.

Other tracking systems can also be used. For example, the display and/or user can be tracked using an acoustic or ultrasonic method and inertial tracking, such as the Intersense IS-900. Another example is to track a user with a magnetic method using ferrous materials, such as the Polhemus Fastrak™. A third example is to use optical tracking, such as the 3rdTech Hiball™. A fourth example is to use mechanical tracking, such as boom interfaces for the display and/or user. FakeSpace Boom 3C (discontinued) and WindowVR by Virtual Research Systems, Inc. are two examples of boom interfaces.

Data related to the physiological and pharmacological status of the MPS can be relayed in real time to the display so that the required changes in the abstract or concrete overlaid/interposed representations are appropriate. Similarly, models running on the virtual simulation can send data back to the MPS and affect how the MPS runs. Embodiments of the subject invention can utilize wired or wireless communication elements to relay the information.

In an embodiment, the display providing the virtual simulation can include a tangible user interface (TUI). That is, similarly to a Graphical User Interface (GUI) in which a user clicks on buttons and slider bars to control the simulation (interactive control), the TUI can be used for control of the simulation. However, in contrast to a typical GUI, the TUI is also an integral part of that simulation—often a part of the phenomenon being simulated. According to an embodiment, a TUI provides a simulation control and represents a virtual object that is part of the simulation. In this way, interacting with the real object (e.g., the physical object or simulator or instrument) facilitates interaction with both the real world and the virtual world at the same time while helping with suspension of disbelief and providing a natural intuitive user interface. For example, by interacting with a real tool as a tangible interface, it is possible to interact with physical and virtual objects. In one embodiment, effects that are not visible, explicit or obvious, such as the efficacy of skin sterilization and infectious organism count can be visualized through the virtual representation when the user is applying a tracked scrub applicator over a surface of a mannequin patient simulator. As a user performs the motions for applying a skin sterilizing agent using the tracked scrub applicator, the virtual representations can reflect the efficacy of such actions by, for example, a color map illustrating how thorough the sterilization and images or icons representing organisms illustrating how pervasive the infectious organism count over time.

According to an embodiment, a user can interact with a virtual simulation by interacting with the real object or physical simulator. In this manner, the real object or physical simulator becomes a TUI. Accordingly, the interface and the virtual simulation are synchronized. For example, in an implementation using an anesthesia machine, the model of the gas flowmeters (specifically the graphical representation of the gas particles' flow rate and the flowmeter bobbin icon position) is synchronized with the real anesthesia machine such that changes in the rate of the simulated gas flow correspond with changes in the physical gas flow in the real anesthesia machine.

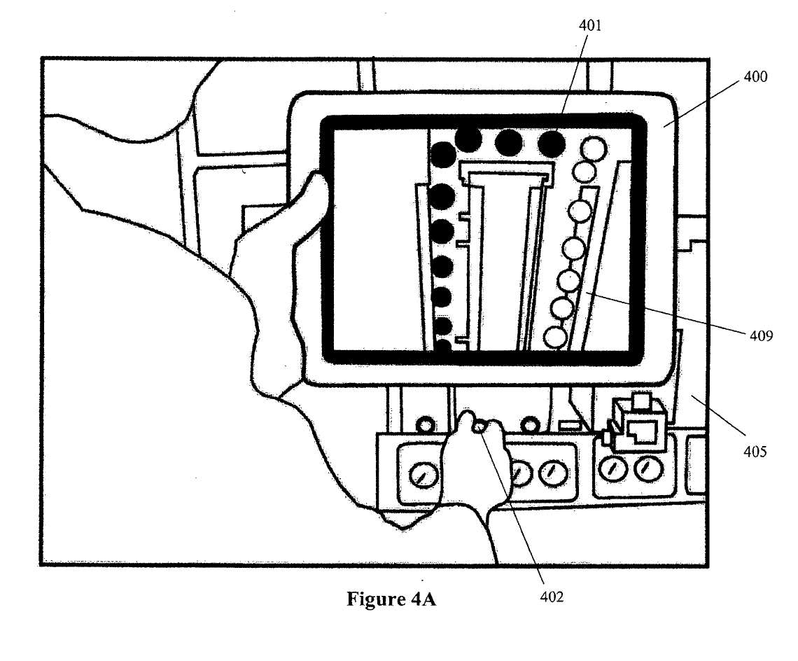

Referring to FIG. 4A, if a user turns the nitrous oxide (N₂O) knob 402 on the real anesthesia machine 405 to increase the real N₂O flow rate, the simulated N₂O flow rate will increase as well. Then, the user can visualize the flow rate change on the magic lens (400) interactively, as the color-coded particles 401 (icons representing the N₂O gas “molecules”) will visually increase in speed until the user stops turning the knob. Thus, the real machine is an interface to control the simulation of the machine and the transparent reality model visualization (e.g., visible gas flow and machine state) is synchronized with the real machine.

With this synchronization, users can observe how their interactions with the real machine affect the virtual model in context with the real machine. The overlaid diagram-based dynamic model enables users to visualize how the real components of the machine are functionally and spatially related, thereby demonstrating how the real machine works internally.

By using the real machine controls as the user interface to the model, interaction with a pointing device can be minimized. In further embodiments interaction with the pointing device can be eliminated, providing for a more real-world and intuitive user interaction. Additionally, users get to experience the real location, tactile feel and resistance of the machine controls. Continuing with the real anesthesia machine example, the O₂ flowmeter knob is fluted while the N₂O flowmeter knob is knurled to provide tactile differentiation.

In an embodiment, the synchronization can be accomplished using a detection system to track the setting or changes to the real object or simulator (e.g., the physical flowmeters of the real anesthesia machine which correspond to the real gas flow rates of the machine). In one embodiment, the detection system can include motion detection via computer vision techniques. Then, the information obtained through the computer vision techniques can be transmitted to the simulation to affect the corresponding state in the simulation. For example, the gas flow rates (as set by the user on the real flowmeters) are transmitted to the simulation in order to set the flow rate of the corresponding gas in the transparent reality simulation.

In another embodiment, the real object or physical simulator can provide signals (e.g. through a USB, serial port, wireless transmitter port, etc.) indicative of, or that can be queried about, the state or settings of the real object or physical simulator.

According to a specific implementation for the anesthesia machine, a 2-D optical tracking system can be employed to detect the states of the anesthesia machine. Table 1 describes an example set-up. In addition, FIG. 8 shows a block diagram of a specific implementation of the tracking system.

TABLE 6.1
Methods of Tracking Various Machine Components

| Machine Component | Tracking Method |
|---|---|
| Flowmeter knobs | IR tape on knobs becomes more visible as |
| | knob is turned. IR webcam tracks 2-D area |
| | of tape. |
| APL Valve Knob | Same method as flowmeters. |
| Manual Ventilation Bag | Webcam tracks 2-D area of the bag's color. |
| Airway Pressure Gauge | Webcam tracks 2-D position of the red |
| | pressure gauge needle. |
| Mechanical Ventilation | Connected to an IR LED monitored by an IR |
| Toggle Switch | webcam. |
| Flush Valve Button | Same method as mechanical ventilation |
| | toggle switch |
| Manual/Mechanical | 2-D position of IR tape on toggle knob is |
| Selector Knob | tracked by an IR webcam. |

Referring to Table 1, state changes of the input devices (machine components) can be detectable as changes in 2-D position or visible marker area by the cameras. For example, to track the machine's knobs and other input devices, retro-reflective markers can be attached and webcams can be used to detect the visible area of the markers. When the user turns the knob, the visible area of the tracking marker increases or decreases depending on the direction the knob is turned (e.g. the O₂ knob protrudes out further from the front panel when the user increases the flow of O₂, thereby increasing the visible area of the tracked marker). In this example, because retro-reflective tape is difficult to attach to the machine's pressure gauge needle and bag, the pressure gauge and bag tracking system can use color based tracking (e.g., the 2-D position of the bright red pressure gauge needle).

Many newer anesthesia machines have a digital output (such as RS-232, USB, etc.) of their internal states. Accordingly, in embodiments using machines having digital outputs of their internal states, optical tracking can be omitted and the digital output can be utilized.

Embodiments of the present invention can provide a magic lens' for mixed or augmented reality, combining a concrete or abstract virtual display with a physical object or simulation. According to embodiments of the present invention for mixed and augmented reality, the magic lens can be incorporated in a TUI and a display device instead of a 2-D GUI. With an augmented-reality lens, the user can look through the ‘lens’ and see the real world augmented with virtual information within the ‘region of interest’ of the lens. In an embodiment, the region of interest can be defined by a pattern marker or an LCD screen or touchscreen, for example, of a tablet personal computer. The ‘lens’ can act as a filter or a window for the real world and is shown in perspective with the user's first-person perspective of the real world. Thus, in a specific implementation, the augmented-reality lens is implemented as a hand-held display tangible user interface instead of a 2-D GUI. The hand-held display can allow for six degrees of freedom. In one embodiment, the hand-held display can be the main visual display implemented as a tracked 6DOF (six degrees of freedom) tablet personal computer.

Referring to FIGS. 4B and 4C, to visualize the superimposed gas flowmeters, users look through a tracked 6DOF magic lens. The ‘lens’ allows users to move it or themselves freely around the machine and view the simulation from a first person perspective, thereby augmenting their visual perception of the real machine with the overlaid VAM model graphics (e.g. portion 410). The relationship between the user's head and the lens is analogous to an OpenGL camera metaphor. The camera is positioned at the user's eye, and the projection plane is the lens; the ‘lens’ 400 renders the VAM simulation directly (shown as element 410) over the machine from the perspective of the user. Through the ‘lens’ 400, users can view a first-person perspective of the VAM model (e.g., portions 409 and 410) in context with a photorealistic or 3-D model 411 of the real machine (see FIG. 4B reference 405). The photorealistic or 3-D machine model appears on the display providing the ‘lens’ in the same position and orientation as the real machine, as if the lens was a transparent window (or a magnifying glass or a lens with magic properties such as rendering hidden, internal, abstract or invisible processes visible and explicit) and the user was looking through it.

To more efficiently learn concepts, users sometimes require interactions with the dynamic model that may not necessarily map to any interaction with the physical phenomenon. For example, the virtual simulation can allow users to “reset” the model dynamics to a predefined start state. All of the interactive components are then set to predefined start states. This instant reset capability is not possible for certain real objects. For example, for a real anesthesia machine it is not possible to reset the gas particle states (i.e. removing all the particles from the pipes) due to physical constraints on gas flows.

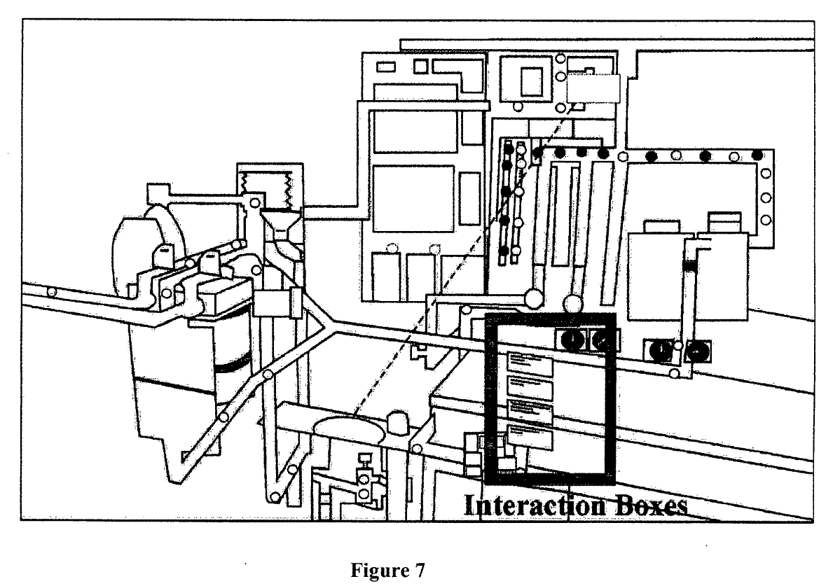

Although the user cannot instantly reset the real gas flow, the user does have the ability to instantly reset the gas flow visualization. This can be accomplished using a pointer, key, pen, or other input device of the display (e.g., 906 of FIG. 9). The input device can serve as an interface to change the simulation visualization for actions that may not have a corresponding interaction with a physical component or may be too onerous, time-consuming, physically strenuous, impractical or dangerous to perform physically.

In certain embodiments of the subject tracking system, it is possible to automatically capture and record where a trainee is looking and for how long as well as whether certain specially marked and indexed objects and instruments in the tracked simulation environment (beyond the physical simulation or object) such as airway devices, sterile solution applicators or resuscitation bags are picked up and used, facilitating assessment and appropriate simulated response and greatly enhancing the capabilities of an MPS or physical simulator.

This can be useful for after-action review (AAR) and also for training purposes during the simulations and debriefing after the simulations. For example, in training and education (e.g., healthcare and anesthesia education), students need repetition, feedback, and directed instruction to achieve an acceptable level of competency, and educators need assessment tools to identify trends in class performance. To meet these needs, current video-based after-action review systems offer educators and students the ability to playback (i.e., play, fast-forward, rewind, pause) training sessions repeatedly and at their own pace. Most current after-action review systems consist of reviewing videos of a student's training experience. This allows students and educators to playback, critique, and assess performance. In addition, some video-based after-action review systems allow educators to manually annotate the video timeline—to highlight important moments in the video (e.g. when a mistake was made and what kind of mistake). This type of annotation helps to direct student instruction and educator assessment. Video-based after-action review is widely used in training because it meets many of the educators' and students' educational needs. However, video-based review typically consists of fixed viewpoints and primarily real-world information (i.e. the video is minimally augmented with virtual information). Thus, during after-action review, students and educators do not enjoy the cognitive, interactive, and visual advantages of collocating real and virtual information in mixed reality.

Therefore, in an embodiment, collocated after-action review using embodiments of the subject mixed simulator system can be provided to: (1) effectively direct student attention and interaction during after-action review and (2) provide novel visualizations of aggregate student (trainee) performance and insight into student understanding and misconceptions for educators.

According to an embodiment, a user can control the after-action review experience from a first-person viewpoint. For example, users can review an abstract simulation of an anesthesia machine's internal workings that is registered to a real anesthesia machine.

During the after-action review, previous interactions can be collocated with current real-time interactions, enabling interactive instruction and correction of previous mistakes in situ (i.e. in place with the anesthesia machine). Similar to a video-based review, embodiments of the present invention can provide recording and playback controls. In further embodiments, these recorded experiences can be collocated with the anesthesia machine and the user's current real-world experience.

According to one implementation, students (or trainees) can (1) review their performance in situ, (2) review an expert's performance for the same fault or under similar conditions in situ, (3) interact with the physical anesthesia machine while following a collocated expert guided tutorial, and (4) observe a collocated visualization of the machine's internal workings during (1), (2), and (3). During the after-action review, a student (or trainee) can playback previous interactions, visualize the chain of events that made up the previous interactions, and visualize where the user and the expert were each looking during their respective interactions. The anesthesia machine is used only as an example—the principle would be similar if the anesthesia machine was replaced by, for example, a mannequin patient simulator or automotive engine.

To generate visualizations for collocated after-action review, two types of data can be logged during a fault test or training exercise: head-gaze (or eye-gaze) and physical object or simulator states. Head-gaze can be determined using any suitable tracking method. For example, a user can wear a hat tracked with retro-reflective tape and IR sensing web cams. This enables the system to log the head-gaze direction of the user. The changes in the head-gaze and physical object or simulator states can then be processed to determine when the user interacted with the physical object or simulator. A student (or trainee) log is recorded when a student (or trainee) performs a fault test or training exercise prior to the collocated after-action review.

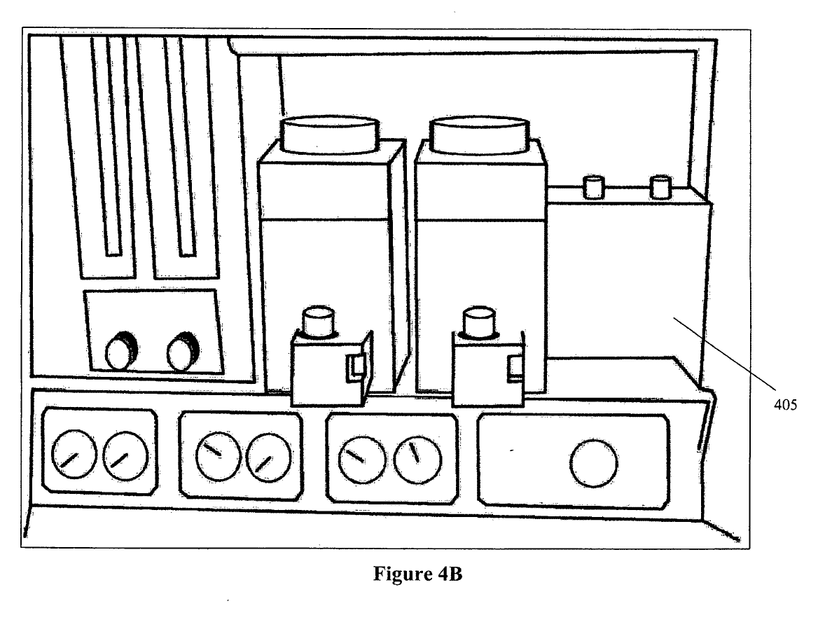

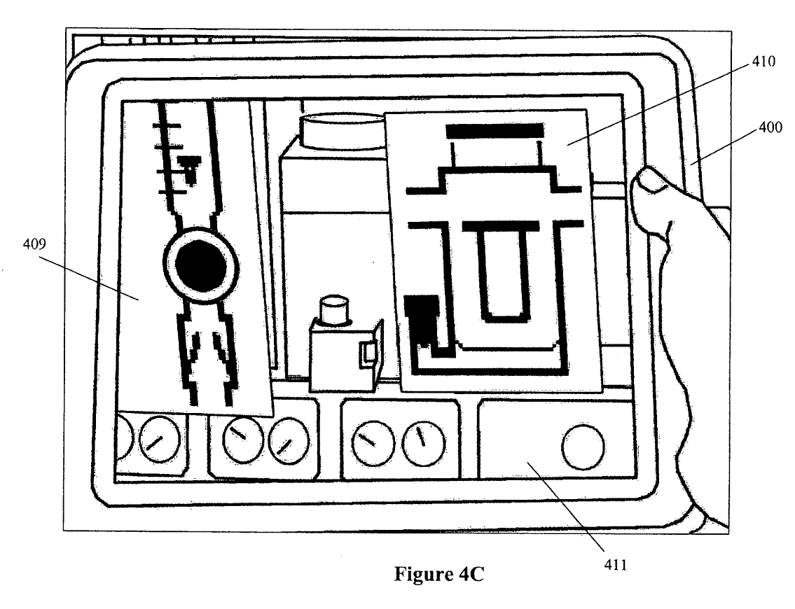

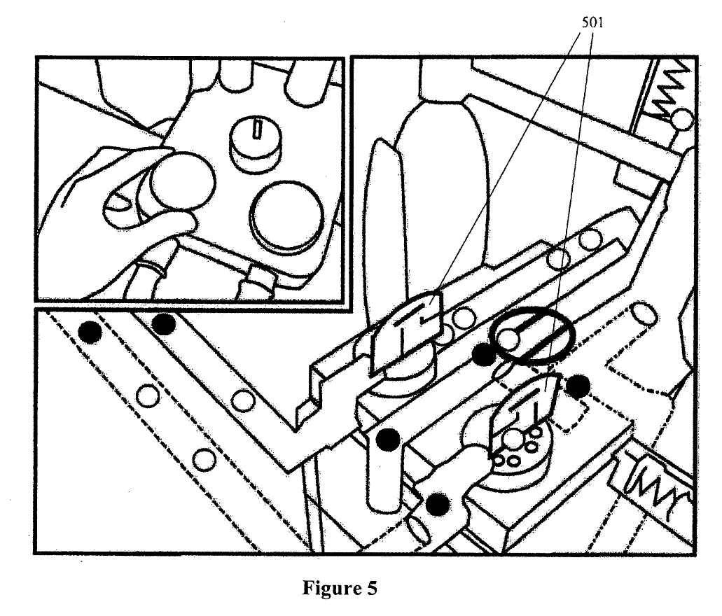

FIGS. 5-7 illustrate an embodiment where the physical object or simulator is an anesthesia machine. Referring to FIG. 5, students physically interact with the real anesthesia machine and use a 6DOF magic lens to visualize how these interactions affect the internal workings and invisible gas flows of the real anesthesia machine. Similarly, to visualize fault behavior during training specific faults can be physically caused in the real anesthesia machine and triggered or reproduced in the abstract simulation. For example, one fault involves a faulty inspiratory valve, which can be potentially harmful to a patient. The top left inset of FIG. 5 shows what the student sees of a real anesthesia machine, while the main image shows what the student sees on the magic lens. Because the magic lens visualizes abstract concepts, such as invisible gas flow, students (or trainees) can observe how a faulty inspiratory valve affects gas flow in situ. As shown in FIG. 5, the abstract valve icons are both open (e.g. the horizontal line 501 is located at the top of the icon, which denotes an open valve). One of the difficulties that students experience in a fault test or training exercise (and in the after-action review of the test or exercise) is in knowing where to direct their attention. There are many concurrent processes in an anesthesia machine and it can be difficult for students to know where to look to find the faults or learn the most salient facts about the system. To address this problem, in embodiments of the collocated after-action review, students can see a visualization of where they were looking or where the expert was looking during the fault test or training exercise. For example, as shown in FIG. 6, a “look-at indicator” (indicated by a circle, boxed, or highlighted region) helps students to direct their attention in the after-action review and allows them to compare their own observations to the expert's observations. In addition, referring to FIG. 7, when an event occurs during playback, an “interaction event box” that is collocated with the corresponding control can appear. For example, when the student turned the O₂ knob, an interaction box pops up next to the control and reads that the student increased the O₂ flow by a specific percentage. To direct the user's attention to the next event, a 3-D line can be rendered that slowly extends from the last interaction event position and towards the position of the next upcoming event. This line can be in a distinctive color, such as red. Lines between older events can be a different color, such as blue, indicating that the events have passed. By the end of the playback timeline, these lines connect all the interactions that were performed in the experience. This forms a directed graph where the interaction boxes are the nodes and the lines are the transitions between them. Accordingly, embodiments of the present invention can provide a collocated after-action review implemented through mixed reality.

FIG. 9 shows a block diagram of a mixed simulator training system according to an embodiment of the present invention. According to an embodiment, the mixed simulator training system can include a real object or physical simulator 900, a tracking system 901, and a visual display 902. The visual display can display a virtual model or simulation of the real object or physical simulator 900. A user (or trainee) 903 can physically and visually interact with the real object or physical simulator 900 while also viewing the virtual model or simulation on the visual display 902. Status state information from the real object or physical simulator 900 and data from the tracking system 901 can be stored in a storage device 904. For reviewing purposes, the tracking system 901 can be used to track head gaze or eye gaze and location of the user 903. The tracking system 901 can also include tracking of the visual display 902 for allowing continual registration of visual display position with the real object or physical simulator 900 aiding ‘magic lens’ capabilities of the visual display 902. In further embodiments, the tracking system 901 can also include tracking of the real object or physical simulator 900. A processing block 905 can be used to implement the software code for the system and control and process signals from the various devices. The processing block 905 can be a part of one or more computers or logic devices. The visual display can include an optional input device 906 for inputting instructions from a user that are not mapped to an interaction with, or reproduced in, the real object or physical simulator 900.

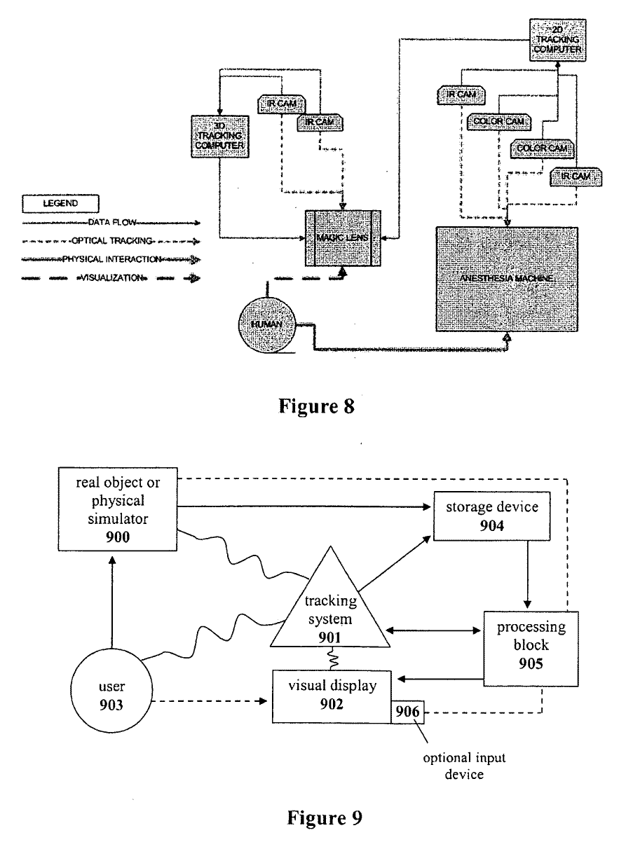

A method of integrating a diagram-based dynamic model, the physical phenomenon being simulated, and the visualizations of the mapping between the two into the same context is provided with reference to FIGS. 10-12. The following description relates to a specific implementation of an augmented anesthesia machine that combines the virtual anesthesia machine (VAM) model (described, for example, in U.S. Pat. No. 7,128,578, which is incorporated by reference in its entirety) with a real anesthesia machine; and demonstrates the integration of a diagram-based dynamic model, the physical phenomenon being simulated and the visualizations of the mapping between the model and the physical phenomenon into the same context. However, embodiments are not limited thereto. According to this implementation, the VAM components are reorganized to align with the real machine. Then, the spatially reorganized components are superimposed into the user's view of the real machine. Finally, the simulation is synchronized with the real machine, allowing the user to interact with the diagram-based dynamic model (VAM model) through interacting with the real machine controls, such as the flowmeter knobs. By combining the interaction and visualization of the VAM and the real machine, embodiments of the present invention can help students to visualize the mapping between the VAM model and the real machine.

To provide visual contextualization (i.e. visualizing the model in the context of the corresponding physical phenomenon), each diagrammatic component can be visually collocated with each anesthesia machine component.

According to an embodiment, the contextualization comprises: (1) transforming the 2-D VAM diagrams into 3-D objects (e.g. a textured mesh, a textured quad, or a retexturing of the physical phenomenon's 3-D geometric model) and (2) positioning and orienting the transformed diagram objects in the space of the corresponding anesthesia machine component (i.e. the diagram objects must be visible and should not be located inside of their corresponding real-component's 3-D mesh).

FIG. 10 shows a diagram illustrating transforming a 2-D VAM diagram into a 3-D object according to an embodiment of the present invention. Referring to FIG. 10, each VAM component is manually texture-mapped to a quad and then the quad is scaled to the same scale as the corresponding 3-D mesh of the physical component. Next each VAM component quad is manually oriented and positioned in front of the corresponding real component's 3-D mesh—specifically, the side of the component that the user looks at the most. For example, the flowmeters' VAM icon is laid over the real flowmeter tubes. The icon is placed where users read the gas levels on the front of the machine, rather than on the back of the machine where users rarely look. Alternatively, the machine model can be textured or more complex 3-D models of the diagram can be used rather than texture mapped 3-D quads.

In a further embodiment, to display the transformed diagram in the same context as the 3-D mesh of the physical component, the diagram and the physical component's mesh can be alpha blended together. This allows a user to be able to visualize both the geometric model and the diagrammatic model at all times. In another embodiment, the VAM icon quads can be opaque, which can obstruct the underlying physical component geometry. However, since users interact in the space of the real machine, they can look behind the display to observe machine operations or details that may be occluded by VAM icons.

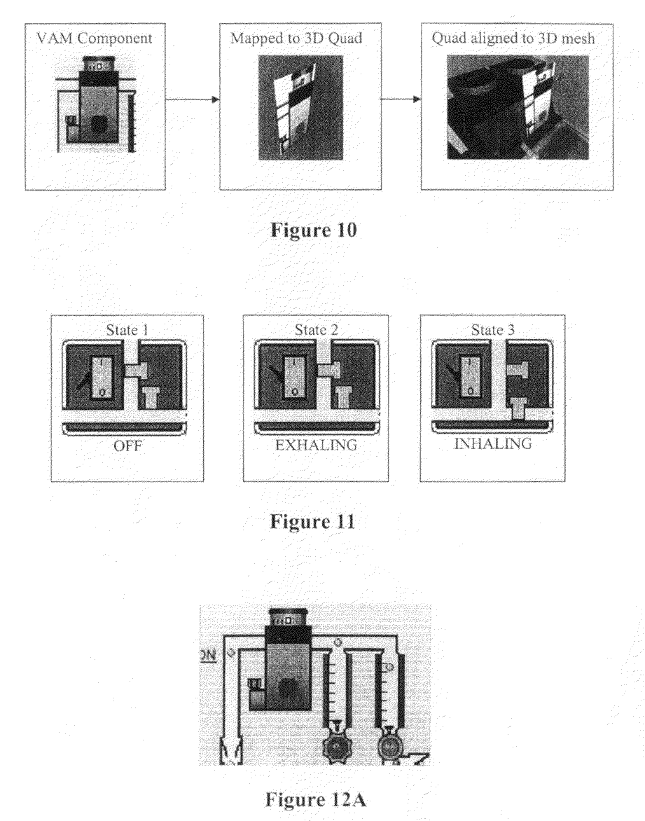

There are many internal states of an anesthesia machine that are not visible in the real machine. Understanding these states is vital to understanding how the machine works. The VAM shows these internal state changes as animations so that the user can visualize them. For example, as shown in FIG. 11, the VAM ventilator model has three discrete states: (1) off, (2) on and exhaling and (3) on and inhaling. A change in the ventilator state will change, for example, the visible flow of the representations (icons or animated 3-D particle) of the gases.

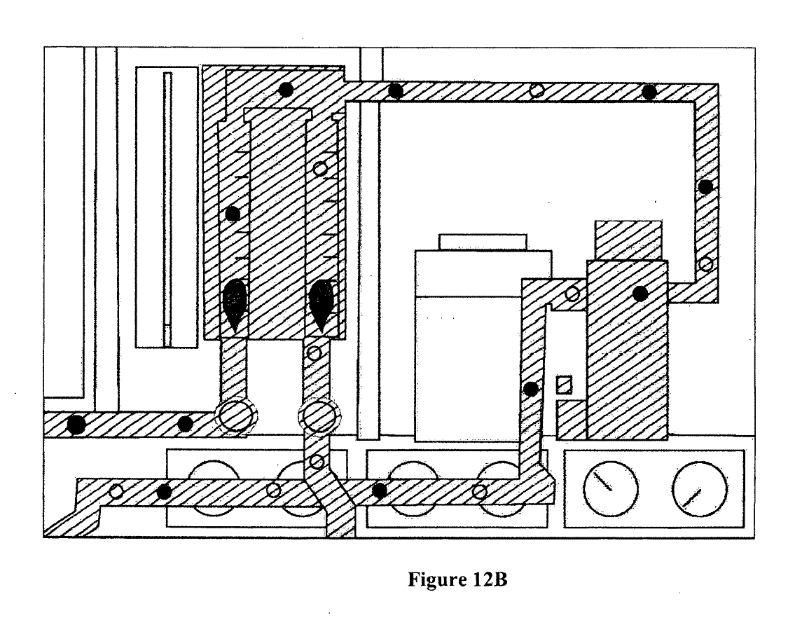

Students may also have problems with understanding the functional relationships between the real machine components. To show the functional relationships between components, the VAM uses 2-D pipes. The pipes are the arcs through which particles flow in the VAM model. The direction of the particle flow denotes the direction that the data flows through the model. In the VAM, these arcs represent the complex pneumatic connections that are found inside the anesthesia machine. However, in the VAM these arcs are simplified for ease of visualization and spatial perception. For example, the VAM pipes are laid out so that they do not cross each other, to ease the data flow visualization. Referring to FIGS. 12A and 12B, the 2-D model arcs (shown in FIG. 12A) can be transformed to 3-D objects (shown in FIG. 12B).

According to one embodiment as shown in FIG. 12B, the pipes can be visualized as 3-D cylinders that are not collocated with the real pneumatic connections inside the physical machine. Instead, the pipes are simplified to make the particle flow simpler to visualize and perceive spatially. This simplification emphasizes the functional relationships between the components rather than focusing on the spatial complexities of the pneumatic pipe geometry. The pipes can be arranged such that they do not intersect with the machine geometry or with other pipes. However, in transforming these arcs from 2-D to 3-D, some of the arcs may appear to visually cross each other from certain perspectives because of the complex way the machine components are laid out. In the cases that are unavoidable due to the machine layout, the overlapping sections of the pipes can be distinguished from each other by, for example, assigning the pipes different colors.

It should be noted that although the methods for integrating a diagram-based dynamic model, the physical phenomenon being simulated, and the visualizations of the mapping between the two in the same context have been described with respect to the VAM and an anesthesia machine, embodiments are not limited thereto. For example, these methods are applicable to any kind of physical simulation or object or object interaction that is to be the subject of the training or simulation.

These examples involve an MPS and an anesthesia machine for healthcare training and education, but embodiments are not limited thereto. Embodiments of the mixed simulator can combine any kind of physical simulation or object or instrument that is to be the subject of the training or simulation, such as a car engine, an anesthesia machine, a scrub applicator or a photocopier, with a virtual representation that enhances understanding.

Accordingly, although this disclosure describes embodiments of the present invention with respect to a medical simulation utilizing MPSs and anesthesia machines, embodiments are not limited thereto.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

What is claimed is:

1. A mixed simulator system comprising:
a physical object; and
a virtual model of the physical object, wherein the virtual model is implemented using a virtual model implement such that the virtual model coexists with the physical object in the same visual space of a user.

2. The mixed simulator system according to claim 1, wherein the virtual model further comprises concrete or abstract models of structures, functions, and/or processes of the physical object, wherein the concrete or abstract models are mapped to and reflected on the virtual model of the physical object.

3. The mixed simulator system according to claim 1, wherein the virtual model implement comprises a display device.

4. The mixed simulator system according to claim 3, wherein the display device comprises a hand-held device comprising a display and is capable of performing logic functions.

5. The mixed simulator system according to claim 1, wherein the virtual model implement comprises a projector for projecting images onto the physical object.

6. The mixed simulator system according to claim 1, wherein the virtual model is linked with the physical object such that manipulations of the physical object are reflected in the virtual model.

7. The mixed simulator system according to claim 6, further comprising a detection system capable of tracking settings or changes to the physical object, wherein the detection system communicates status states or state changes of the physical object to the virtual model.

8. The mixed simulator system according to claim 6, wherein the physical object is capable of providing signals indicative of status states or settings or state changes of the physical object to the virtual model.

9. The mixed simulator system according to claim 1, wherein interaction with the physical object results in a change in the virtual model.

10. The mixed simulator system according to claim 9, wherein the physical object provides a tangible user interface for the virtual model.

11. The mixed simulator system according to claim 1, wherein interaction with the virtual model results in a change to the physical object.

12. The mixed simulator system according to claim 11, wherein data from models running on the virtual model is transmitted to the physical object using wired or wireless communication elements.

13. The mixed simulator system according to claim 1, wherein the physical object comprises a physical simulator.

14. The mixed simulator system according to claim 13, wherein data from models running on the physical simulator is transmitted to the virtual model using wired or wireless communication elements.

15. The mixed simulator system according to claim 1, wherein interaction with the virtual model provides a virtual simulation of a change to the physical object.

16. The mixed simulator system according to claim 1, further comprising an instrument for applying or interacting with the physical object, wherein the virtual model includes information or representations of effects of the application or interaction between the instrument and the physical object.

17. The mixed simulator system according to claim 1, further comprising a tracking system for tracking the user, the virtual model implement and/or the physical object, wherein the tracking system communicates position and orientation information for modifying the virtual model to reflect changes to position and orientation of the tracked user, virtual model implement and/or physical object.

18. The mixed simulator system according to claim 1, further comprising a tracking system for determining the location and orientation of the physical object with respect to the user and/or virtual model implement as the user and/or virtual model implement moves around the physical object.

19. The mixed simulator system according to claim 1, further comprising an input device for receiving instructions from the user that are not mapped to an interaction with or reproduced in the physical object.

20. The mixed simulator system according to claim 1, wherein the virtual model implement co-locates images of the virtual model and the physical object in the same visual space of the user.

21. A method of training utilizing the system of claim 1.

22. A mixed reality training system comprising:
a physical object;
a tracking system to determine position of a user with respect to the physical object;
a computer implemented virtual model of the physical object; and
a visual display configured to illustrate the virtual model, wherein the visual display of the virtual model is spatially registered with the physical object.

23. The training system according to claim 22, wherein the computer implemented virtual model further comprises concrete or abstract models of structures, functions, and/or processes of the physical object.

24. The training system according to claim 22, wherein the tracking system further determines position and/or orientation of the visual display with respect to the physical object.

25. The training system according to claim 24, wherein the visual display is configured to present an augmented-reality lens for a region of the physical object in accordance with the position of the visual display as determined by the tracking system.

26. The training system according to claim 22, wherein the tracking system captures information on head gaze or eye gaze of a user, the system further comprising a storage device storing the captured information on the head gaze or the eye gaze of the user and information on status states of the physical object for each interaction scenario.

27. The training system according to claim 26, wherein the information on the head gaze or eye gaze of the user comprises information on where on the physical object and for what length of time the user is looking.

28. The training system according to claim 26, wherein the information on the storage device is collocated with the virtual model to provide a computer implemented after-action review.

29. The training system according to claim 28, wherein the visual display further displays the after-action review.

30. The training system according to claim 28, wherein the computer implemented after-action review is further collocated with a real-time interaction of the user with the physical object.

31. The training system according to claim 26, wherein the visual display further displays a look-at indicator for indicating a previous head gaze location and duration from one or more stored interaction scenarios.

32. The training system according to claim 31, wherein the previous head gaze location from the one or more stored interaction scenarios comprises an expert's stored interaction scenario.

33. The training system according to claim 26, wherein the visual display further displays a look-at indicator for indicating an aggregate head gaze location and duration of one or more users.

34. The training system according to claim 26, wherein the visual display further displays interaction event boxes collocated with a corresponding element in the illustrated virtual model for indicating a previous interaction from one or more stored interactions.

35. The system according to claim 22, further comprising an input device for receiving instructions from the user that are not mapped to an interaction with or reproduced in the physical object.

36. The system according to claim 35, wherein the input device is connected to the visual display.

37. The interactive training mixed simulator system according to claim 22, wherein the physical object comprises elements providing tactile and haptic feedback.

38. A method of training utilizing the system of claim 22.

39. A simulator for training medical practitioners, comprising:
a physical simulator or real object; and
a virtual simulator for providing virtual representations of internal functions of the physical simulator or the real object, wherein the virtual simulator is implemented to coexist with the physical simulator or the real object in the same visual space of a user.

40. The simulator according to claim 39, wherein the virtual simulator communicates with the physical simulator such that a user action in the virtual simulator causes a response in the physical simulator.

41. The simulator according to claim 39, wherein the physical simulator communicates with the virtual simulator such that a user action in the physical simulator causes a response in the virtual simulator.

42. The simulator according to claim 39, further comprising a means for communicating status states of the real object to the virtual simulator, wherein a user action with respect to the real object causes a response in the virtual simulator.

43. The simulator according to claim 39, wherein the virtual simulator communicates with the real object such that a user action in the virtual simulator causes a response in the real object.
